(19) United States
(12) Patent Application Publication
(10) Pub. No.: US 2008/0147419 A1
(43) Pub. Date: Jun. 19, 2008

(54) Website for recording/registering real estate buyer/agency agreements or contracts

(76) Inventor: Moses Bliss Chukwuemeka Odinachi, Charlotte, NC (US)

Correspondence Address: MOSES BLISS CHUKWUEMEKA ODINACHI, 2611 Holton Ave. #6, Charlotte, NC, 28208, US

(21) Appl. No.: 11/637,652

(22) Filed: Dec. 13, 2006

(51) Int. Cl. G06Q 50/00

(52) U.S. Cl. 705/1

(57) ABSTRACT

Currently there is no one source of electronic database information, no internet website dedicated for buyer/agency information of buyers and agents/brokers representing them. This innovative invention will enable an online electronic database for all buyers in the real estate market holding or engaged in exclusive buyer/agency relationship with real estate firms/brokers. At this website, real estate agents/brokers will be able to input new buyer information and identification at any time, to record, verify, update, terminate, (if mutually necessary,) and renew existing buyer/agency contract. The website will automatically indicate, to a verifying agent/broker, if a buyer he/she intends to represent has an existing un-expired or expired buyer/agency agreement with another brokerage/broker.

### FIELD OF THE INVENTION

This invention pertains to the practice of real estate business in the United States of America. It is aimed at securing the buyer/agency relationships as entered into by the agent/broker and the buyer.

It precludes any subsequent buyer/agency contracts and enables invalidation of any such subsequent buyer/agency attempted or completed with same buyer by any other agent during the effective period of the recorded buyer/agency contract.

### BACKGROUND OF INVENTION

This field of invention pertains to the business of real estate. Real estate brokers and firms normally would have a buyer/agency agreement in order to claim exclusive buyer/agency representation and be the procuring cause of sale to be entitled to any commission from the real estate transaction. At the moment, real estate brokers often get into disputes resulting from dishonest buyers who would not disclose existing buyer/agency relationship with another brokerage/broker. This inherent conflict will be minimized, if not totally eliminated, if all agents, brokers, real estate firms and companies start using this website. One agent, for one buyer, at one time.

### SUMMARY OF INVENTION

This innovative invention will enable an online electronic database of all buyers in the real estate market holding or engaged in exclusive buyer/agency relationship with real estate firms/brokers. At this website, real estate agents/brokers will be able to input new buyer information and identification at any time, to record, verify, update, terminate, (if mutually necessary,) and renew existing buyer/agency contract. The website will automatically indicate, to a verifying agent/broker, if a buyer he/she intends to represent has an existing un-expired or expired buyer/agency agreement with another brokerage/broker.

### DETAILED DESCRIPTION OF THE INVENTION

1. At this website, a new user will be prompted to register in order to use it.
2. Only licensed real estate agents and brokers will be allowed to login and input their client's information.
3. To login, a user will first select their State either by clicking the name of their state on the map on the Home page, or by a drop down arrow. Then, select City.
4. No one will be able to login without first registering the real estate firm/company he/she is associated with.
5. To register the Firm/Company, a user (Firm/Company owner, broker in-charge, or representative) will be prompted to input the Firm/Company information.
6. Then the Firm/Company is assigned a User-Identification.
7 To use the system, the individual broker/agent will be able to login after he/she has provided their Firm/company assigned login identification.
8. After being assigned a login name, each real estate firm will be able to choose a unique password which the broker in-charge or owner will share with their agents.
9. Then to register/record their clients, the agent will login with their Firm/Company login name and password.
10. Then the user will input their client's identification—Name, Address, Social Security Number, and so on.
11. After inputting the client's information, the system will promptly indicate if the client is (a real buyer) currently available or not.
12. If the client is available (not signed up with another Brokerage), the system will show the BUYER NOT ASSIGNED.
13. If the client is current registered and is working with another brokerage, the system will show BUYER ASSIGNED.
14. If the buyer is not assigned, the system will allow the broker/agent to proceed with the registration.
15. If the system shows buyer assigned, the agent will be able to verify which brokerage the client is working with.
16. If the buyer/agency agreement with the previous brokerage/firm has been is expired, terminated, or renewed, the system will indicate accordingly.

What is claimed is:

1. An interactive website that will enable an agent to record/register a new real estate buyer he/she has entered into an exclusive buyer/agency relationship with.

2. The agent/realtor/broker, while at the website of claim 1, will be able to authenticate, search for, and verify that the buyer he/she intends to engage in exclusive buyer/agency relationship, does not have an existing buyer/agency agreement for representation, with another agency, agent broker, brokerage or real estate firm.

3. Website of claim 1 will also enable the agent to update the buyer/buyers' information with regards to whether an expired buyer/agency contract is mutually extended.

4. While in the interactive website of claim 1, agents having existing exclusive buyer/agency relationship with a buyer will be able to terminate the agreement after consultation or at the request of their prospective buyers. Such updates must indicate accordingly, but no further reason may be provided.

5. The website of claim 1, 2, and 3, wherein a buyer information is recorded, will also indicate the date buyer/agency contract was entered into by the parties, and the date such contract is due to expire.

6. The website of claim 1, 2, and 3 will be exclusively used for buyers with exclusive buyer/agency agreement with their brokers.

7. When used by all agents, the website of claim 1, wherein agents records/registers a new real estate buyer, will enable only one agent/broker for one real estate buyer at a time.

8. When used by all agents, the website of claim 1, 2, and 3 will be able to minimize the inherent conflict, misunderstandings, and disappointment associated with situations where two agents are working for one buyer unknowingly.

9. When used by an agent, the interactive website of claim 1, will enable the agent consolidate his/her claim of a buyer/agency relationship with a buyer, superceding another, if any, in the event of a conflict.

10. The website of claim 1, 2, and 3, wherein an agents verifies buyer/agency information, will automatically disallow any attempt to record/register an already registered/recorded buyer/buyers on the website.
